(19) United States
(12) Patent Application Publication
(10) Pub. No.: US 2020/0300806 A1
(43) Pub. Date: Sep. 24, 2020

(54) MICRO-ELECTROCHEMICAL SENSOR

(71) Applicant: The Board of Trustees of the Leland Stanford Junior University, Stanford, CA (US)

(72) Inventors: Pierre-Alexandre GROSS, Mountain View, CA (US); Beth L. PRUITT, San Francisco, CA (US); Thomas JARAMILLO, Palo Alto, CA (US)

(21) Appl. No.: 16/607,629

(22) PCT Filed: Apr. 30, 2018
(86) PCT No.: PCT/US2018/030195

§ 371 Date: Oct. 23, 2019

Related U.S. Application Data
(60) Provisional application No. 62/491,416, filed on Apr. 28, 2017.

(51) Int. Cl. G01N 27/416; G01N 27/407; G01N 27/404; G01F 1/64; G01N 27/327

(52) U.S. Cl. CPC G01N 27/4162; G01N 27/4074; G01N 27/4045; C08L 27/22; G01N 27/3277; G01N 27/4076; G01F 1/64

(57) ABSTRACT

Disclosed are improved micro-electrochemical sensor structures that uses cyclic voltammetry (CV) to perform electrochemical measurements on gaseous volatile organic compounds (VOC). The improved sensor structures include a Ag reference electrode layer and an adhesion SU-8 layer. Operationally, the oxidation of the Ag layer provides a reference potential that is used to determine the redox reactions occurring on the surface of Pt electrodes exposed to a flow of gaseous VOC. Experimentally, our improved sensor was used to detect methane dissolved in N2. The results show clear and reproducible oxidation signals that were attributed to the presence of methane in the gas flow. The position of this signal for methane was compared to CO, and was found to be clearly separated from it, proving the speciation capabilities of the sensor. In addition, our experiments showed that it is possible to use the current value to quantify the detected molecule in the gas flow.

### CROSS REFERENCE TO RELATED APPLICATIONS

This application claims the benefit of Untied States Provisional Patent Application Ser. No. 62/491,416 filed 28 Apr. 2017 which is incorporated by reference as if set forth at length herein.

### TECHNICAL FIELD

This disclosure relates generally to sensors and more particularly to the structure, fabrication, characterization, and testing of an electrochemical Volatile Organic Compound (VOC) sensor operating in gaseous condition at room temperature.

### BACKGROUND

As will be readily appreciated by those skilled in the art, given the impact of volatile organic compounds on the environment specifically and human health generally, the ability to detect trace amounts of gas phase volatile organic compounds is of significant importance in contemporary society. Consequently, improved and/or novel systems, methods, and structures that facilitate such gas phase detection of volatile organics would represent a welcome addition to the art.

### SUMMARY

An advance in the art is made according to an aspect of the present disclosure directed to improved micro-electrochemical sensor structures that uses cyclic voltammetry (CV) to perform electrochemical measurements on gaseous volatile organic compounds (VOC). The improved sensor structures include a Ag reference electrode layer and an adhesion SU-8 layer. Operationally, the oxidation of the Ag layer provides a reference potential that is used to determine the redox reactions occurring on the surface of Pt electrodes exposed to a flow of gaseous VOCs. Experimentally, our improved sensor was used to detect methane dissolved in N₂. The results show clear and reproducible oxidation signals that were attributed to the presence of methane in the gas flow. The position of this signal for methane was compared to CO, and was found to be clearly separated from it, proving the speciation capabilities of the sensor. In addition, our experiments showed that it is possible to use the current value to quantify the detected molecule in the gas flow.

### BRIEF DESCRIPTION OF THE DRAWING

A more complete understanding of the present disclosure may be realized by reference to the accompanying drawing in which:

FIG. 1 shows a plot illustrating an ideal detection curve of an electrochemical gas sensor according to aspects of the present disclosure;

FIG. 2 shows an exploded view of an illustrative electrochemical sensor according to an aspect of the present disclosure;

FIG. 3(A) shows a schematic diagram of an illustrative gas sensing setup according to aspects of the present disclosure;

FIG. 3(B) shows a plot of an illustrative curves obtained during activation steps of sensors according to aspects of the present disclosure;

FIG. 4(A) shows a CV plot of the detection of 50% Methane in N₂ according to aspects of the present disclosure;

FIG. 4(B) shows a CV plot of the detection of 10% Methane in N₂ according to aspects of the present disclosure;

FIG. 5(A) shows a plot of the evolution of a Methane signal over time @ 0.38V vs. IntRef for both 50% Methane in N₂ and 10% Methane in N₂ according to aspects of the present disclosure;

FIG. 5(B) shows processed detection data for Methane and CO in the form of differentiable peaks according to aspects of the present disclosure;

### DETAILED DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope. More particularly, while numerous specific details are set forth, it is understood that embodiments of the disclosure may be practiced without these specific details and in other instances, well-known circuits, structures and techniques have not been shown in order not to obscure the understanding of this disclosure.

Furthermore, all examples and conditional language recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently-known equivalents as well as equivalents developed in the future, i.e., any elements developed that perform the same function, regardless of structure.

Thus, for example, it will be appreciated by those skilled in the art that the diagrams herein represent conceptual views of illustrative structures embodying the principles of the disclosure.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means which can provide those functionalities as equivalent as those shown herein. Finally, and unless otherwise explicitly specified herein, the drawings are not drawn to scale.

Thus, for example, it will be appreciated by those skilled in the art that the diagrams herein represent conceptual views of illustrative structures embodying the principles of the disclosure.

By way of some further background, we begin by noting that methane (CH₄) is at least 25 times more effective at trapping heat in the atmosphere than carbon dioxide (CO₂), making it a dangerous contributor to the green-house gas effect. Additionally—while methane is nontoxic—it is extremely flammable and may form explosive mixtures with air. For these and other reasons, the detection of Methane emissions is of great importance for both safety and for environmental reasons.

As is known, two major sources of methane associated with human activity are agriculture (188 million-ton CH₄ per year) and fossil fuel production and usage (105 million-ton CH₄ per year). According to the United States Department of Transportation distribution pipelines carrying natural gas to homes and businesses in the US—of which methane is a significant component—suffer an average of one leak every other day. These factors create a major need for sensing technologies capable of detecting methane leaks and emissions. Finally, we note that while natural gas is a mixture of gases, methane is in the highest proportion (>80%) and is also the most volatile due to the small size and non-polarity of the molecule.

Despite such need and importance, modern methane (and other gas) leak detection systems are oftentimes operated only intermittently and require large pieces of equipment to be carried along pipelines. These leak detection systems and sensors are oftentimes loaded in the back of a truck, van, automobile, airplane, and frequently employ detection technologies using an infrared analysis. Two such types of infrared analysis systems that are frequently employed for leak detection employ optical and spectroscopic techniques. An alternative, Optical Gas Imaging (OGI) approach gathers video images recorded in the infrared (IR) region, which are then analyzed algorithmically to identify gas leaks.

Those skilled in the art will appreciate that one quality measure of any method used to identify gas leaks is the maximum distance from which leaks can be detected. Another quality measure is whether or not a chemical identification may be made of a detected gas stream. Accordingly, spectroscopic methods that employ—for example—an infrared spectrometer to analyze the IR absorption spectrum of air sampled near pipelines—may advantageously determine such chemical compositions as collected spectra may exhibit absorption lines corresponding to methane or other known natural gas components. This information—coupled with data from a Global Positioning Systems (GPS)—allows for determining the specific chemical composition and location of detected leaks.

Notwithstanding that infrared detection techniques are very precise, they are nevertheless quite costly, operated only intermittently and may still require several human operators.

A promising alternative to these infrared methods that overcomes a number of these issues employs micro-sensors. Advantageously, micro-sensors may be constructed using known micro-fabrication techniques and materials and are therefore relatively inexpensive and mass deployable. Of particular attraction—given their relatively low expense, modest power requirements and small size—such micro-sensors may provide first-hand, continuous monitoring of natural gas or other facilities and be deployed physically close to pipeline junctions were most of leaks are known to occur.

Prior art attempts to micro-fabricate sensors based on IR detection principles have been made, and in particular sensor chips based on the principle of mid-infrared Fiber-optic Evanescent Wave Spectroscopy (FEWS) have been developed. However, these sensors are difficult to manufacture, and they require efficient and inexpensive mid-infrared laser diodes.

One of the more promising micro-sensor approaches for the detection of VOCs—including methane and other hydrocarbons—employ metal-oxide sensors. Such metal-oxide sensors are relatively easy to manufacture and easily integrated with other electronic components to produce sufficiently sensitive yet inexpensive devices. Such metal-oxide sensors rely on the measurement of a change in conductivity between two electrodes as molecules adsorb on an oxide sensing layer situated in between them.

In typical prior art configurations, this sensing layer is usually composed of a nanostructured metal oxide such as ZnO, SnO₂, or TiO₂—the particular choice of which depends on the targeted molecule as each one of these metal oxides exhibits a high affinity for a particular VOC. Unfortunately, one disadvantages of metal-oxide sensors is that they require heating of the sensing layer to high temperatures (300-500° C.), and they are not conducive to quantifying the specific concentrations of gasses.

Accordingly, we disclose an electrochemical sensor for CV that advantageously overcomes the noted limitations of the prior art while maintaining any advantages. Of particular interest, compatibility with contemporary micro-fabrication techniques, cost effectiveness, and system integration possibilities are maintained.

As we shall describe, the sensing principle for our electrochemical sensors is based on the measurement of an oxidation or reduction current as a voltage is swept between two potential limits (E₁ and E₂) at two electrodes namely, a working electrode (WE) and a counter electrode (CE). When this swept voltage reaches the redox potential of a molecule adsorbed on the electrode, it gets oxidize or reduced, and generates a measurable current at this applied voltage. With the help of a third reference electrode (RE), the applied voltage that triggers a reaction can be associated with a particular redox reaction. A last component, the electrolyte, is necessary to complete this process. The role of the electrolyte is to conduct ionic products from the WE to the CE thereby closing the electrochemical circuit.

We note that existing chemical sensors based on a similar sensing principle oftentimes employ Ytteria Stabilized Zirconnia (YSZ) electrolytes which conduct oxygen ions. Unfortunately, however, these solid-state electrolytes only conduct ions at high operating temperatures (500-700° C.). Given this undesirable attribute, a polymeric electrolyte, i.e., Nafion, is employed in structures according to the present disclosure such that operation at room temperature is made possible.

We note further that redox reactions of molecules discussed herein are presented—along with their standard redox potential against the Standard Hydrogen Electrode (SHE)—for the complete oxidation of methane into CO₂ and for the oxidation of CO into CO₂ in the following equations:

CH₄+H₂O↔CO₂+6H⁺+6e⁻ E⁰=0.17V [1]

CO+H₂O↔CO₂+2H⁺+2e⁻ E⁰=0.52V [2]

Note that in a typical detection experiment using such a sensor, a CV curve generated is analyzed using a series of mathematical processes to extract any valuable information. As will be known and understood by those skilled in the art, the output of CV measurements (cyclic voltammograms) can be separated into two branches. The first branch—from E₁ to E₂ is where oxidation reactions are observed—is called the anodic branch. The second branch—from E₂ to E₁ is where reduction reactions are observed—is called the cathodic branch.

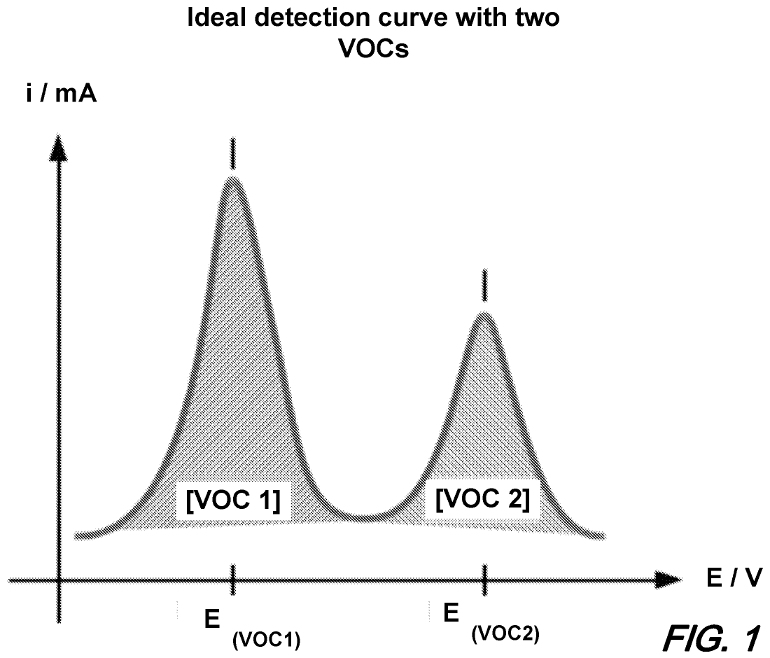

In the case of oxidations (cases presented herein), only the anodic branch contains detection information, therefore the cathodic branch can be eliminated from consideration. Accordingly, a baseline curve, acquired under inert atmosphere, is subtracted from the curve exhibiting the detected oxidation peaks. Ideally, this mathematical process generates a curve that resembles the one shown in FIG. 1 in which one peak for each molecule that has been oxidized on the surface of the electrodes is plotted. From the position of these peaks, specific molecules can then be identified and the area under the peaks can be used to determine the concentration of detected molecules after calibration with a known concentration of the molecules.

We finally note that we have previously patented and published some early work on the detection of carbon monoxide (CO) using electrochemical principles and showed that a sensor having two Pt electrodes and a solid-state electrolyte such as Nafion is capable of detection and identification. While Pt has a strong affinity for CO and is relatively easy to detect using our electrochemical techniques, methane is far less reactive and its adsorption on metallic surfaces at room temperature is very weak and is the limiting step of any electrocatalytic process where it is involved.

Nevertheless, this electrochemical sensing principle can in theory detect any organic molecule, as all such organic molecules can be either oxidized or reduced. Accordingly, we disclose herein an improved solid-state electrochemical sensor for the detection, identification, and quantification of methane—and in particular—methane dissolved in nitrogen gas, N₂.

In evaluating the performance of our new solid-state electrochemical sensor, we limit the environmental exposure of the sensor to N₂ to better confirm the origin of observed signals. In the configuration employed for evaluation, we expose the sensor to two concentrations of methane and observe its linear response, and subsequently compare the methane signal to a signal obtained during detection of CO—thereby establishing its ability to specifically identify particular VOC species.

### Experimental Fabrication, Characterization, and Results

The design and fabrication for solid-state electrochemical sensors according to the present disclosure builds upon our first-generation sensor. In contrast to our earlier devices however, a silver layer is added between the SiO₂ substrate and the SU-8 to act as a RE. Additionally, a photoresist—SU-8—is used to enhance adhesion of the Nafion layer (which is deposited on top of SU-8) to the substrate, and to limit the dehydration of this layer by retaining water.

Advantageously, and in further contrast to our earlier devices, the sensor disclosed herein includes all required components (WE, CE, RE, electrolyte) to perform cyclic voltammetry on-chip.

We note that the addition of the Ag RE advantageously enables the operation of sensors according to the present disclosure without requiring any external reference electrode in the gas phase. As disclosed herein, potentials measured against this Ag reference are herein referred to as Versus Internal Reference (vs. IntRef). Note further that we fabricate top electrodes from Pt as it exhibits the highest electrocatalytic activity for methane oxidation.

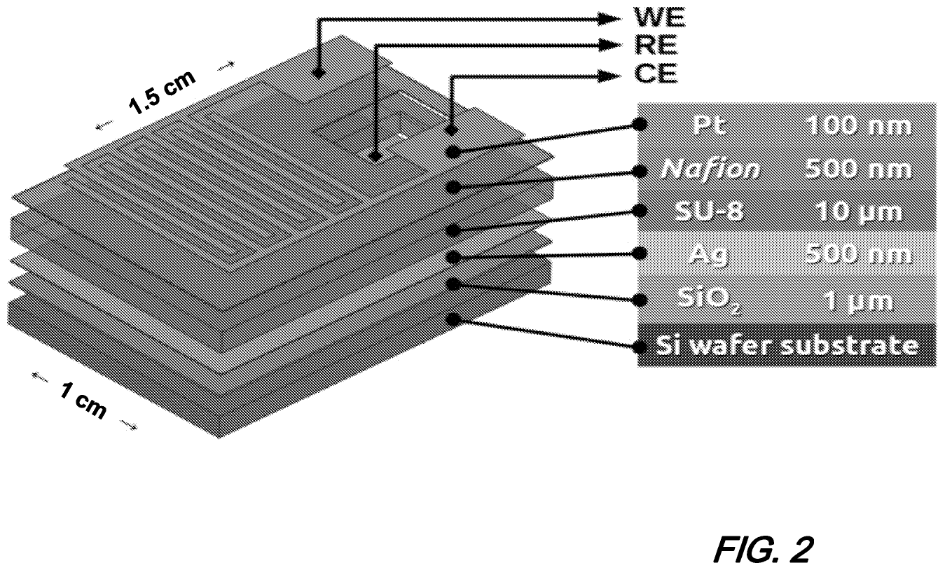

FIG. 2 shows an exploded view of a layer stack comprising an illustrative sensor according to the present disclosure and target thickness(es) for each layer. As shown in that exploded view, a device measuring approximately 1.5 cm×1.0 cm is fabricated from a Si substrate; overlying that substrate is a SiO₂ layer of approximately 1 μm in thickness; an Ag layer of approximately 500 nm in thickness overlies that SiO₂ layer; a photoresist layer of approximately 10 μm thick SU-8 overlies the Ag layer; a 500 nm thick layer of Nafion overlies the photoresist layer; and finally a 100 nm layer of Pt overlies the Nafion and both WE and CE are formed in this Pt. As shown further in this figure, the Ag layer is exposed in a region wherein both Nafion and photoresist have been removed.

Fabrication

A 100 mm diameter, 525 μm thick, Si wafer was cleaned using a succession of baths. The baths were a 9:1 H₂SO₄:H₂O₂ (piranha), followed by 5:1:1 H₂O:H₂O₂:NH₄OH, followed by 50:1 H₂O:HF, and finally 5:1:1 H₂O:H₂O₂:HCl.

A 1 μm thick Si dioxide (SiO₂) layer was grown on the cleaned wafer by wet oxidation at 1100° C. for 2 hrs 15 min. On top of that Si dioxide layer was deposited a Ag layer of substantially 500 nm thick.

A 10 μm thick SU-8 2010 layer was spun on top of the oxide at 1500 rpm for 5 s and then 3000 rpm for 15 s. This SU-8 layer was exposed to a 119 mJ/cm² dose of 365 nm ultraviolet light, baked at 85° C. for 2 min to ensure hardening and drying of the SU-8, and then developed. This layer was subjected to 30 s of O₂ plasma prior to the deposition of the Nafion layer.

A Nafion layer was deposited on the SU-8 layer by two consecutive drop castings of 5 mL of a Nafion D1021 water dispersion directly on the SU-8 layer while the substrate was positioned on a hot plate heated to 100° C., ensuring optimal coverage of the SU-8 surface. The solvent was evaporated between the castings and at the end for 10 min. This deposition process showed better results in layer homogeneity and thickness than the spin coating process used previously.

To complete the layer stack shown illustratively in FIG. 2, a 100 nm thick Pt layer was deposited by e-beam evaporation, at a 1 Å/s rate, through a shadow mask exhibiting the interdigitated electrodes geometry. Once completed, the sensors were diced out of the wafer using a diamond tip scriber, and an electrical access to the Ag layer was cut out through the Nafion and SU-8 membranes (layers) using a razor blade. Layer thicknesses were measured at each step.

Upon completion of the fabrication process, the sensor(s) was/were activated in a liquid environment and tested for the detection of various gases.

### Characterization

All topological characterizations were made using a profilometer and the results are presented in Table 1. Note that the measured thicknesses presented in the table are averaged over the entire wafer and are in good accordance with target thicknesses. The Nafion layer shows some disparity across the wafer but is thicker and more homogeneous than previously prepared using spin coating deposition methods.

The lifetime of the sensors has been tested by constant cycling under N₂ for 6 hrs. The current was stable over a period of 4 hrs. and showed 80% diminution after 6 hrs. of operation. After this period, the sensors were considered stable for testing for ca. 3 hrs.

TABLE 1
The measured thickness of the layers comprising the sensor

Thickness (nm)

| Layer | Target | Measured |
|---|---|---|
| Oxide - SiO2 | 1.000 | 920 |
| Reference - Ag | 500 | 510 |
| Adhesion - SU-8 | 10 000 | 9600 |
| Electrolyte - Nafion | 500 | 600-800 |
| Electrodes - Pt | 100 | 110-120 |

### Results and Discussion

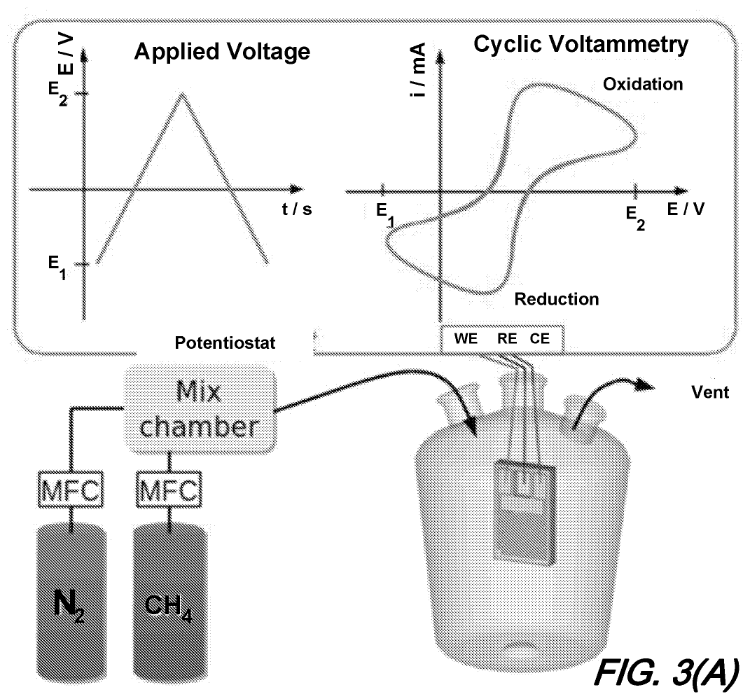

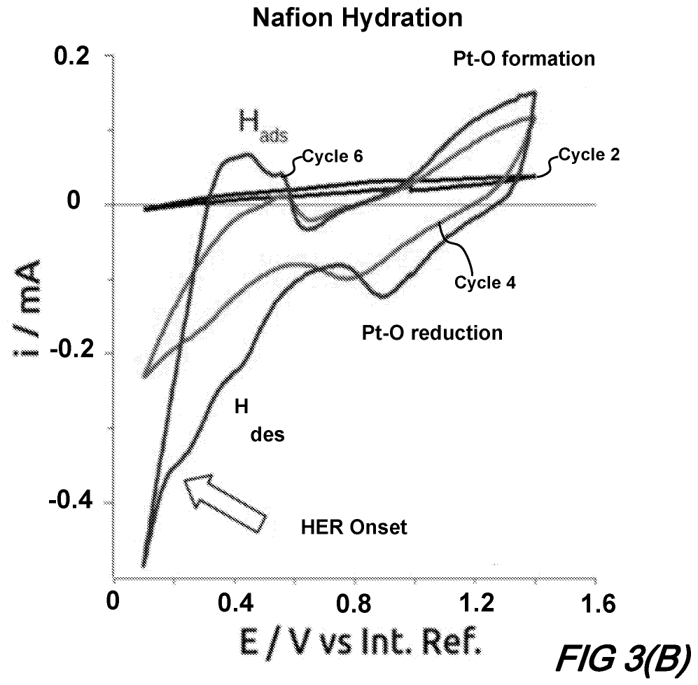

All experiments performed with the sensors were carried out using the test setup shown in FIG. 3A, which includes a glass cell in which the sensor is placed. Through this cell, flowed a gas or a mixture of gases obtained using Micro-Flow Controllers (MFCs) and a mixing chamber. All gas flows are expressed in Standard Cubic Centimeter (sccm). The proportion of each gas is expressed in percentage of the total gas flow of 20 sccm that exits the mixing chamber.

The three electrodes (WE, CE, RE) of the sensor were connected to a Biologic® SP-300 potentiostat that performs CV measurements. CV curves were obtained by applying the triangular voltage (shown in inset) between the WE and the CE while measuring the current at each voltage step. Once this current is plotted against the applied voltage, the CV, was formed and advantageously may be used to extract valuable information about the electrochemical reactions occurring on the surface of the electrodes.

### Activation in Liquid

Hydration of the Nafion layer was carried out by filling the glass cell with an aqueous electrolyte of 0.1 mol/L H₂SO₄ and immersing the sensor in it. Nitrogen gas (N₂) was continuously bubbled in the electrolyte as the CVs were recorded between E₁=0.1 V vs IntRef and E₂=1.4 V vs IntRef. These limits were determined on larger scans spanning from −2 V vs IntRef to 2 V vs IntRef to find the position of the Hydrogen Evolution Reaction (HER) which corresponds to 0 V on the SHE scale. Once observed close to 0.1 V vs IntRef, the upper limit was chosen in the Pt-oxides capacitive region located at slightly higher potential than their formation i.e. 1.3 to 1.5 V higher.

This experiment in liquid environment allowed both hydration and acidification of the Nafion layer. Cycles 2, 4 and 6 of this electrochemical characterization experiment are shown in FIG. 3B. One can see that cycle 2 shows no signal due to the absence of active oxidation of the Ag into Ag oxide since no water was yet in contact with it. As the experiment continued, signals started to appear until the complete CV of Pt in acidic media was formed showing the typical peaks of Hydrogen adsorption (H_{ads}) and desorption (H_{des}), and Pt-oxide formation and reduction. Once this curve was obtained, the Nafion and SU-8 membranes were considered fully hydrated, thus the Ag layer could be oxidized and used as a reference redox potential during detection experiments. The onset of the Hydrogen Evolution Reaction (HER) was measured as 0.186 V vs IntRef in cycle 6. This value corresponds to the reference electrode shift that must be used to normalize the observed redox signals against the SHE. The normalized value against SHE allows the identification of chemical species undergoing redox reactions on the surface of the Pt electrodes.

Note that each solid-state sensor chip has to be calibrated individually to determine this value, as a small variation, <5 mV, has been observed. We attributed this to a slightly different chemical environment near the Ag layer due to small variations in the thicknesses of the SU-8 and Nafion layers.

### Testing in Gas

Once the sensor has been activated in liquid, the surface of the sensor was dried out using an air stream and used for gas detection experiments. Our detection experiments were carried out in the same electrochemical cell, but without the liquid electrolyte as shown in FIG. 3A. The gas flowed directly in the cell, at a constant flow rate of 20 sscm, after passing through a mixing chamber. All CVs were performed at constant sweep rate of a 100 mV/s. The flow rate and sweep rate were chosen to make sure that the electrochemical processes involving methane are limited by its chemisorption on the Pt surface, as suggested by kinetical studies of methane oxidation on noble metal surfaces, rather than being limited by diffusion.

Typical experiments were carried out by first acquiring a baseline curve with only N₂ flowing through the cell, then the N₂ was adjusted proportionally as methane was added to the flow to keep the total flow constant. Two detection experiments were performed with methane: (i) 50% methane in N₂ (10 sccm methane and 10 sccm N₂) and (ii) 10% methane in N₂ (2 sccm methane and 18 sccm N₂). Finally, the methane was turned off and N₂ flowed alone in the cell to follow the recovery of the sensor as the curve returned to the baseline.

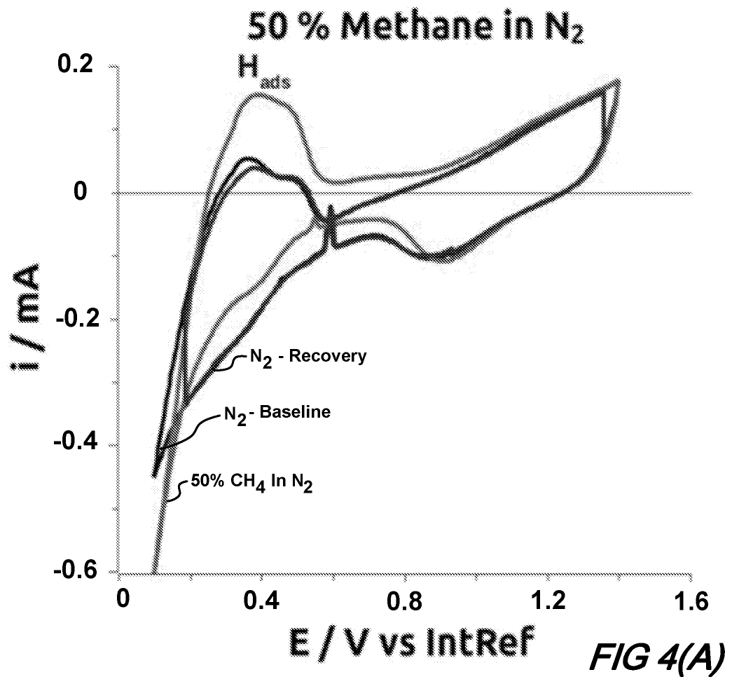

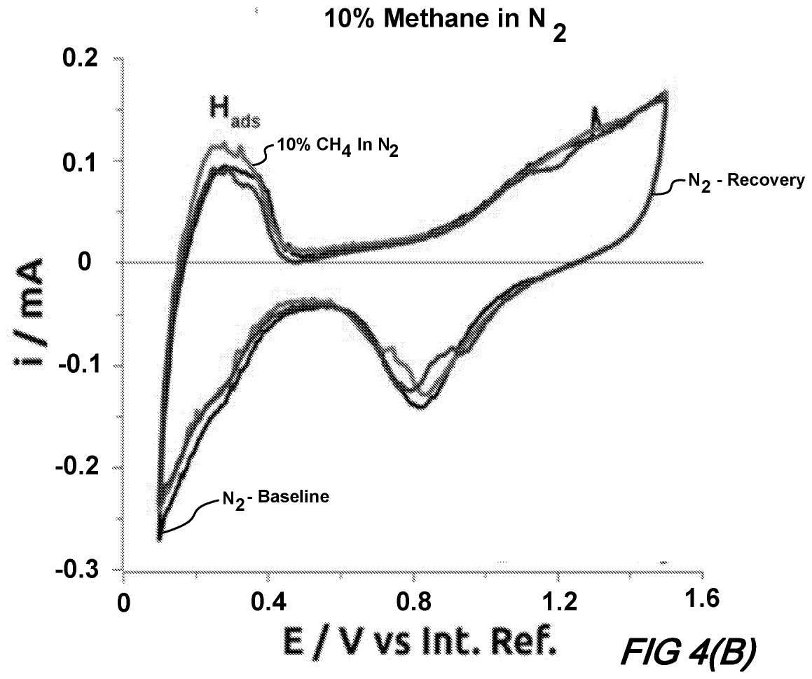

Detection results are presented graphically in FIG. 4(A) and FIG. 4(B), which shows raw CVs acquired during testing experiments described earlier, with 50% and 10% of methane in N₂, respectively. On these plots are only represented the first (baseline), the last (recovery) and the highest methane signal cycles. Intermediate cycles are not represented for clarity.

One observation that can be made is the increase in current from the H_{ads} region of the Pt curve located between 0.1 and 0.6 V vs IntRef. The position of this current increase cannot be attributed to the direct oxidation of methane into CO₂ because—although the standard redox potential for the oxidation of methane into CO₂ is indeed in that region (0.17 V vs SHE)—some over-potential is required for the oxidation to occur. Methane is known to be the least reactive hydrocarbon at room temperature, which is why its detection is so difficult. Therefore, in the present conditions, observing direct electro-oxidation of methane into CO₂ is unlikely. However, observing a stable, reproducible, and proportional signal, even from indirect electrochemical processes and in controlled atmosphere, is very encouraging for the detection of this molecule, especially using a sensor with such a simple design and fabrication process and at room temperature.

Some observations about these curves support the presence of an indirect electrochemical process involving methane. First, the overall shape of the curve is maintained in the region of increase, which suggests a hydrogen-related process. The particular shape of the H_{ads} region is due to the fact that the current generated by the adsorption of H on the Pt surface happens on different crystallographic planes.

The precise origin of this additional H is unclear. However, it is related to the presence of methane as it is observed only when it is present in the flow. Finally, one can also observe that when methane is present in the gas flow, the HER current increased. This feature is especially evident in FIG. 4(A), with higher concentration of methane, and suggests again that H is generated during the exposure of the sensor to methane.

One hypothesis that may explain this excess of H in the system is that methane is only partially oxidized, and that intermediate chemical species are generated on the surface along with adsorbed H atoms, which could be the origin of the increase in the H_{ads} current. The partial oxidation of methane is also supported by the anaerobic experimental conditions. These adsorbed H atoms may then be reduced into H₂, inducing the increase in HER current observed on the curve. However, no clear oxidation signal, which could be attributed to methane oxidation, is observed to support this hypothesis. Yet, the fact that the overall curve is shifted upwards and straightened, especially in the case of 50% methane in the flow, shows an overall increase in conductivity that could come from the increase in conductivity of the Nafion layer as the concentration of protons in it increase.

A final observation about these curves concerns the cathodic branch. The Pt-O reduction peak is shifted towards higher potentials when methane is present in the flow. This difference suggests that the methane reaction involved changes in the hydration state of the Pt oxides, which confirms the involvement of H₂O in the reaction²⁷. However, this observation can also suggest that the presence of methane induces different crystalline sites to be oxidized differently, thus generating a Pt-O reduction doublet.

The formation of such doublet is clearly observed in the experiment with 10% methane as shown in FIG. 4(B), during the recovery phase under N₂. Indeed, as shown by DFT calculations, the adsorption of methane is strongly tied to the crystalline structure and the crystalline sites present to allow bonding with the surface Pt atoms.

The precise electrochemical analysis of the curves obtained during testing experiments is non-trivial due to several reasons. The first is the absence of oxygen (O₂) in the system, as methane is mixed only with N₂. The only source of 0 atoms is the water molecules in the Nafion layer. Using these 0 atoms requires additional oxidation reactions to append simultaneously. Then, the oxidation of methane itself is a multiple step, nonlinear process, which generates several intermediates and depends on the hydration and oxidation state of the surface. Finally, almost no work in similar, dry, oxygen free, gaseous conditions, at room temperature, has been reported to the best of our knowledge.

### Signal Treatment

The raw CVs are further transformed using a series of basic mathematical operations. The main signal for the detection of methane being observed on the anodic branch, the cathodic branch can be ignored and removed. Then to isolate the part of the oxidation peak that can be attributed to the presence of methane in the flow, the baseline CV, acquired under N₂ is subtracted from each CV acquired under CH₄ flow.

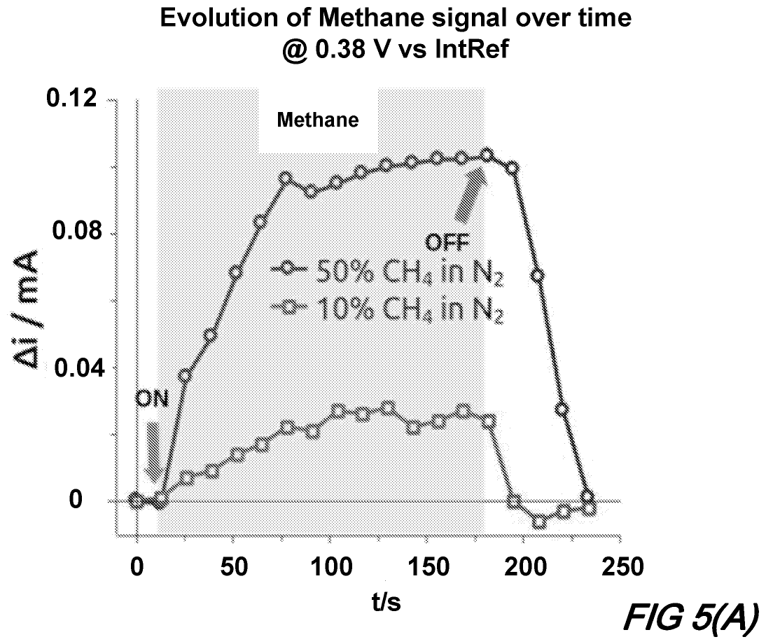

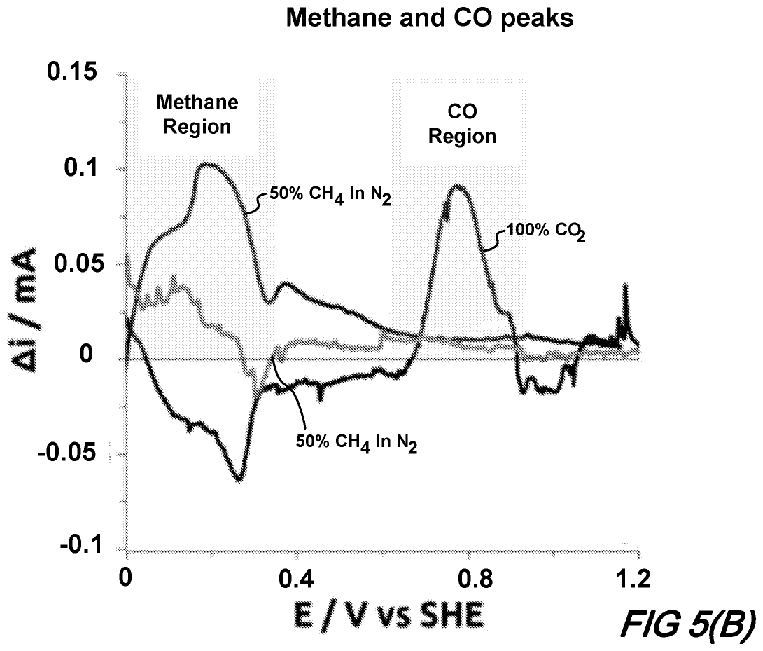

Turning now to FIG. 5(A) and FIG. 5(B), there is shown: FIG. 5(A) a plot of the evolution of a methane signal over time @ 0.38V vs. IntRef for both 50% Methane in N₂ and 10% Methane in N₂; and FIG. 5(B) CV plots illustrating Methane and CO peaks—all according to aspects of the present disclosure.

With respect to FIG. 5(A), it may be observed that the value of the current at 0.38 V vs IntRef, for each cycle of the curves from FIG. 4(A) and FIG. 4(B), is plotted against time which is determined by the 100 mV/s sweep rate. This shows the evolution of the methane signal as well as the linear response of the sensor to the concentration of methane in the flow. On these curves, one can see that the signal increases as soon as methane flows in the cell and continues to increase until it reaches a steady state. The sensor shows a good response time to the presence of methane in the gas flow, of ca. 13 s (the time needed to complete one full cycle) which is in accordance of the good response time of other sensors.

The fact that the curve reaches a steady state shows that the Pt surface becomes saturated and cannot adsorb more methane. These observations are consistent when the concentration of methane in the flow is decreased from 50% to 10%. Moreover, the increase of the signal is proportional to the concentration of methane as it is about five times higher with 50% methane flow than with 10% flow.

This proportionality shows the possibility of using the current value to quantify the concentration of methane and shows the linear response of the sensor to an increasing methane concentration. When methane is removed from the gas flow, it only takes a few cycles to go back to the baseline value, showing the good recovery time (in the order of tens of seconds to a minute) of the sensor. The signal returning to its original value shows that the surface does not get poisoned.

A small overshoot is observed for the 10% methane experiment which can be attributed to the mathematical operation that is performed to obtain this curve. Indeed, a single value has been taken as baseline and has been subtracted from all subsequent curves, but we observed that when the system is left cycling freely under N₂, CVs do not superimpose perfectly and exhibit a small variation ca. 1%. This could possibly be avoided by diminishing the sweep rate of the experiment, however, this would also diminish the current amplitude which is undesired as it is already on the order of tens of μA. Nevertheless, the fact that the curve returns to its original value is another advantage of the cycling, as the application of higher voltages eventually oxidizes and desorbs all molecules.

On FIG. 5(B), the anodic branches of the cycles with the highest current value are plotted together for the two experiments under methane and for an experiment under CO. Additionally, these curves are corrected from the reference electrode shift in order to plot them against the SHE. First, the blue curve (50% methane in N₂) shows a clear peak centered at 0.2 V vs SHE that corresponds to the signal observed on FIG. 4(A). This peak is the main detection signal coming from the presence of methane in the gas flow. When the concentration of methane was decreased to 10%, the detection signal became weaker and the signal to noise ratio decreased. Nevertheless, the maximum of the red curve is in the same region as the blue one suggesting that similar electrochemical processes are happening at lower concentration.

The methane signals were compared to a signal obtained with CO (black curve) in similar conditions and processed using the same mathematical treatments. This experiment was presented in greater detail in our previous publication. The peak observed on the black curve corresponds to CO oxidation into CO₂. The signal is located at 0.8 V vs SHE and is clearly separated from the signals obtained with methane. This result shows that cyclic voltammetry can differentiate molecules by their respective redox potential by producing curves with different peaks for different chemical species.

### CONCLUSION

We have presented an improved solid-state electrochemical gas sensor design that uses CV to perform electrochemical measurements. In sharp contrast to prior art structures the structures according to the present disclosure include an incorporated Ag reference electrode layer positioned underneath an adhesion (SU-8) layer. The oxidation of this Ag layer during operation provides a reference potential that is used to determine the redox reactions occurring on the surface of the Pt electrodes exposed to the gas flow. Our sensor design was used to prove the capability of this sensing principle to detect methane dissolved in N₂. The results show clear and reproducible oxidation signals that were attributed to the presence of methane in the gas flow. The position of this signal for methane was compared to CO, and was found to be clearly separated from it, proving the speciation capabilities of the sensor. In addition, our experiments showed that it is possible to use the current value to quantify the detected molecule in the gas flow.

At this point, those skilled in the art will readily appreciate that while the methods, techniques and structures according to the present disclosure have been described with respect to particular implementations and/or embodiments, those skilled in the art will recognize that the disclosure is not so limited. Accordingly, the scope of the disclosure should only be limited by the claims appended hereto.

1. A solid-state gas sensor comprising:
a Si/SiO₂ substrate;
an Ag reference electrode (RE) layer including a reference electrode overlying the substrate;
an adhesion layer overlying a portion of the reference electrode layer;
a solid-state electrolyte layer including a solid-state electrolyte overlying the adhesion layer; and
a Pt electrode layer including interdigitated working (WE) and counter electrodes (CE) overlying the adhesion layer.

2. The solid-state gas sensor of claim 1 wherein the wherein the solid-state electrolyte is a sulfonated tetrafluoroethylene based fluoropolymer-copolymer.

3. The solid-state gas sensor of claim 2 wherein the SiO₂ substrate exhibits a thickness of up to 1 μm.

4. The solid-state gas sensor of claim 3 wherein the adhesion layer exhibits a thickness of up to 10 μm.

5. The solid-state gas sensor of claim 4 wherein the solid-state electrolyte layer exhibits a thickness of up to 500 nm.

6. The solid-state gas sensor of claim 5 wherein the Pt electrode layer exhibits a thickness of up to 100 nm.

7. The solid-state gas sensor of claim 6 wherein the Ag reference electrode exhibits a thickness of up to 500 nm.

8. A method of fabricating a solid-state gas sensor, said method comprising:
providing a substrate;
growing a SiO₂ layer on a top surface of the substrate;
forming an Ag layer on a top surface of the SiO₂;
depositing a photoresist adhesion layer on a top surface of the Ag layer and exposing the dried photoresist to an O₂ plasma;
depositing, by at least two consecutive drop castings, a solid-state electrolyte layer on a top surface of the adhesion layer;
depositing a Pt electrode layer on a top surface of the solid-state electrolyte; and
removing, a portion of the solid state electrolyte and a portion of the photoresist such that a portion of the Ag layer is exposed.

9. The solid-state gas sensor of claim 8 wherein the wherein the solid-state electrolyte is a sulfonated tetrafluoroethylene based fluoropolymer-copolymer.

10. The solid-state gas sensor of claim 9 wherein the SiO₂ substrate exhibits a thickness of up to 1 μm.

11. The solid-state gas sensor of claim 10 wherein the adhesion layer exhibits a thickness of up to 10 μm.

12. The solid-state gas sensor of claim 11 wherein the solid-state electrolyte layer exhibits a thickness of up to 500 nm.

13. The solid-state gas sensor of claim 12 wherein the Pt electrode layer exhibits a thickness of up to 100 nm.

14. The solid-state gas sensor of claim 13 wherein the Ag reference electrode exhibits a thickness of up to 500 nm.
